(19) United States
(12) Patent Application Publication
(10) Pub. No.: US 2025/0339948 A1
(43) Pub. Date: Nov. 6, 2025

(54) MAGNETIC TYPE QUICK-ASSEMBLE AND QUICK-DISASSEMBLE STRUCTURE FOR HANDLE AND GLOVE WOVEN TAPE

(71) Applicant: Rongrong Li, Xiamen (CN)

(72) Inventor: Rongrong Li, Xiamen (CN)

(21) Appl. No.: 19/271,711

(22) Filed: Jul. 16, 2025

(51) Int. Cl. B25G 1/04; A41D 19/00; B25G 1/06

(52) U.S. Cl. CPC B25G 1/04; A41D 19/0048; B25G 1/06

(57) ABSTRACT

A magnetic type quick-assemble and quick-disassemble structure for a handle and a glove woven tape is provided, including a handle and a glove woven tape. A connection block is disposed at a first web of the glove woven tape, and a connection block magnet is disposed in the connection block. A handle slot adapted to the connection block is embedded in the handle, and left and right lock buckles are symmetrically disposed on two sides of the handle slot along an insertion direction of the connection block. Under the action of the common magnetic field of the left lock buckle magnet, the right lock buckle magnet, the handle adsorption magnet, and the connection block magnet, quick assembly between the handle and the glove woven tape is implemented. Quick disassembly between the handle and the glove woven tape is implemented by using the physical unlocking device.

### TECHNICAL FIELD

The present disclosure relates to the field of magnetic type glove technologies, and in particular, to a magnetic type quick-assemble and quick-disassemble structure for a handle and a glove woven tape.

### BACKGROUND

Most of handles and glove woven tapes on the market are inconvenient to replace due to manual connection or are replaced by professional disassembly tools. In addition, some handles and glove woven tapes are of pure mechanical structures, and are time-wasting and labor-wasting during assembly and disassembly. During assembly, correct alignment and manual buckling are required, and a large amount of manpower and material resources are required.

Therefore, there is an urgent need for a method or structure for assembling a handle and a glove woven tape that are convenient to disassemble and assemble.

### SUMMARY

Aiming at problems proposed in the prior art, provided is a magnetic type quick-assemble and quick-disassemble structure for a handle and a glove woven tape.

The present disclosure provides a magnetic type quick-assemble and quick-disassemble structure for a handle and a glove woven tape. The structure includes a handle and a glove woven tape. A connection block is disposed at a first web of the glove woven tape, and a connection block magnet is disposed in the connection block. A handle slot adapted to the connection block is embedded in the handle, and a left lock buckle and a right lock buckle are symmetrically disposed on two sides of the handle slot along an insertion direction of the connection block, where the left lock buckle and the right lock buckle are respectively disposed in corresponding lock buckle chutes, and a left lock buckle magnet and a right lock buckle magnet are correspondingly disposed in the left lock buckle and the right lock buckle. A handle adsorption magnet is disposed in front of the handle slot along the insertion direction of the connection block. When the connection block approaches the handle slot, under the action of a common magnetic field of the left lock buckle magnet, the right lock buckle magnet, the handle adsorption magnet, and the connection block magnet, the left and right lock buckles slide in the corresponding lock buckle chutes to clamp the connection block.

An unlocking device is further disposed on the top of the handle, and the unlocking device includes an unlocking button, an unlocking upper slant face, and an unlocking lower slant face. The unlocking upper slant face respectively abuts against an upper slant face of the left lock buckle and an upper slant face of the right lock buckle, the unlocking lower slant face respectively abuts against a lower slant face of the left lock buckle and a lower slant face of the right lock buckle, based on that the unlocking button is triggered, the unlocking upper slant face and the unlocking lower slant face move downward and drive the upper and lower slant faces of the left lock buckle and the right lock buckle to move transversely, so that the left lock buckle and the right lock buckle are disengaged from the connection block.

Specifically, one of main technical concepts of the present disclosure lies in that quick assembly between the handle and the glove woven tape is implemented under the action of a common magnetic field of the left lock buckle magnet, the right lock buckle magnet, the handle adsorption magnet, and the connection block magnet; and quick disassembly between the handle and the glove woven tape is implemented by using the physical unlocking device.

Optionally, magnetic poles of the handle adsorption magnet and the connection block magnet are set to be mutually attracted. When the connection block approaches the handle slot, the connection block is capable of being automatically sucked into the handle slot.

Optionally, magnetic poles of the left lock buckle magnet and the right lock buckle magnet are set to be mutually repelled.

Optionally, the handle adsorption magnet and the connection block magnet are both cylindrical, and the left lock buckle magnet and the right lock buckle magnet are both in the shapes of arc-shaped tiles.

Optionally, a handle magnet mounting hole is disposed in the handle, and the lock buckle chutes corresponding to the left lock buckle and the right lock buckle are both disposed between the handle magnet mounting hole and the handle slot.

Optionally, a lock buckle upper blocking wall is disposed at upper ends of the lock buckle chutes corresponding to the left and right lock buckles, and a lock buckle lower blocking wall is disposed at lower ends of the lock buckle chutes corresponding to the left and right lock buckles.

Optionally, the unlocking button includes a button, and a spring and a button fixed pin limiting rib that are fixedly connected to the back of the button by using a spring mounting seat; where the spring is configured to control movement of the unlocking upper slant face and the unlocking lower slant face.

### BRIEF DESCRIPTION OF THE DRAWINGS

The following further describes the present disclosure in detail with reference to the accompanying drawings and preferred embodiments. However, a person skilled in the art will appreciate that the accompanying drawings are drawn only for the purpose of explaining the preferred embodiments, and are therefore not intended to limit the scope of the present disclosure. In addition, unless specifically noted, the accompanying drawings represent conceptually only the composition or construction of the described object and may include exaggeration display, and the accompanying drawings are not necessarily drawn in scale.

FIG. 1 is a schematic structural diagram of a magnetic type quick-assemble and quick-disassemble structure for a handle and a glove woven tape according to an embodiment of the present disclosure;

FIG. 2 is an exploded view of a quick-assemble and quick-disassemble structure according to an embodiment of the present disclosure;

FIG. 3 is a schematic diagram of a cross section of a magnetic type quick-assemble and quick-disassemble structure for a handle and a glove woven tape according to an embodiment of the present disclosure;

FIG. 4 is a schematic diagram of a cross section of a quick-assemble and quick-disassemble structure according to another embodiment of the present disclosure;

FIG. 5 is a schematic diagram of a cross section of a handle according to an embodiment of the present disclosure; and

FIG. 6 is a schematic diagram of a cross section of a handle according to another embodiment of the present disclosure.

### DETAILED DESCRIPTION OF THE EMBODIMENTS

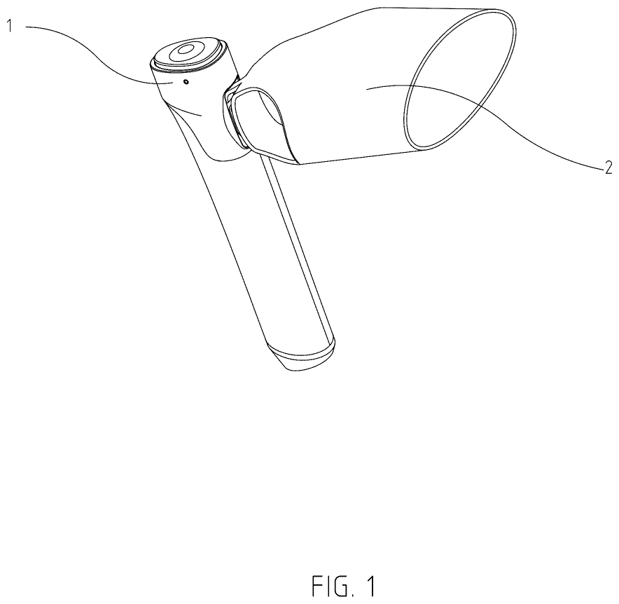

The present disclosure is further described in detail in conjunction with FIG. 1.

In order to make the objectives, technical solutions and advantages of the present disclosure clearer, the present disclosure will be further described hereinbelow with reference to the accompanying drawings and embodiments thereof. It shall be understood that, the embodiments described herein are only intended to illustrate but not to limit the present disclosure.

Main technical concepts of the present disclosure lie in that quick assembly between the handle and the glove woven tape is implemented under the action of a common magnetic field of the left lock buckle magnet, the right lock buckle magnet, the handle adsorption magnet, and the connection block magnet; and quick disassembly between the handle and the glove woven tape is implemented by using the physical unlocking device.

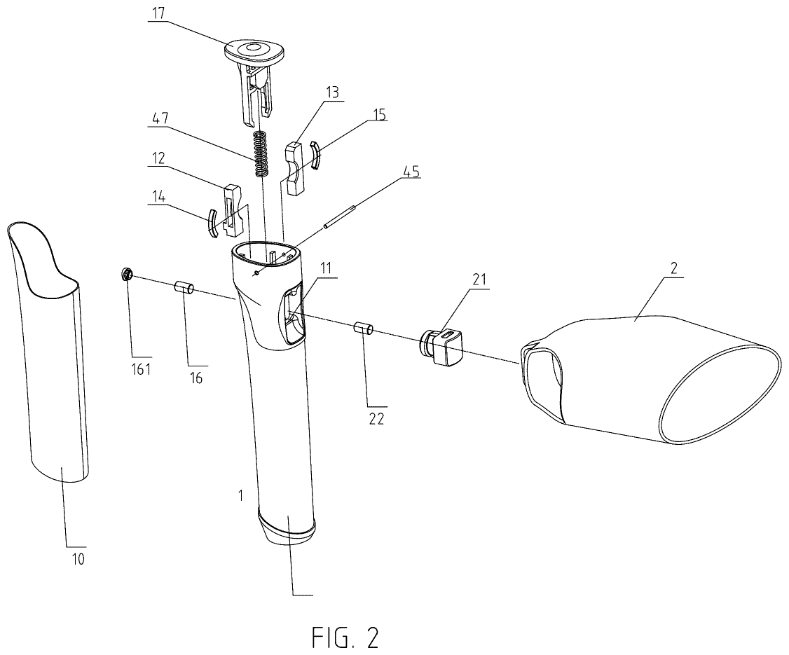

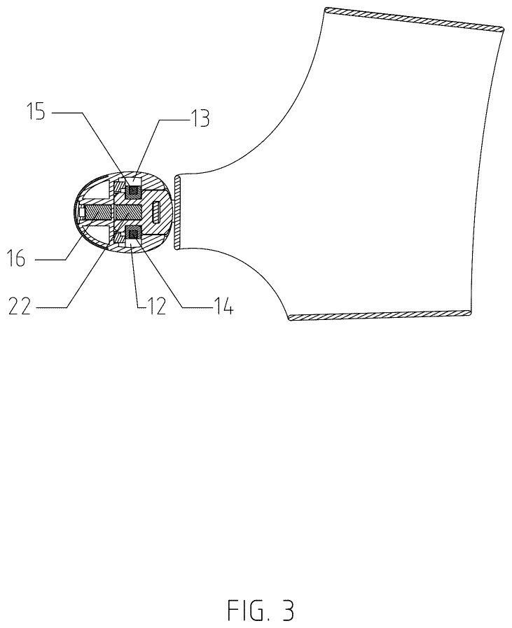

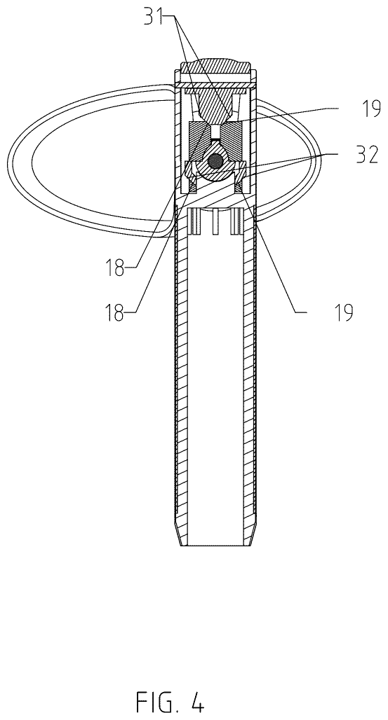

Further, FIG. 1 to FIG. 6 are schematic structural diagrams of a magnetic type quick-assemble and quick-disassemble structure for a handle and a glove woven tape according to an embodiment of the present disclosure.

A magnetic type quick-assemble and quick-disassemble structure for a handle and a glove woven tape provided by the present disclosure includes a handle 1 and a glove woven tape 2. A cork sticker 10 is sleeved on the handle 1. A connection block 21 is disposed at a first web of the glove woven tape 2, and a connection block magnet 22 is disposed in the connection block 21. A handle slot 11 adapted to the connection block 21 is embedded in the handle 1, and a left lock buckle 12 and a right lock buckle 13 are symmetrically disposed on two sides of the handle slot 11 along an insertion direction of the connection block 21, where the left and right lock buckles are respectively disposed in corresponding lock buckle chutes 41, and a left lock buckle magnet 14 and a right lock buckle magnet 15 are correspondingly disposed in the left and right lock buckles. A handle adsorption magnet 16 is disposed in front of the handle slot 11 along the insertion direction of the connection block 21.

When the connection block 21 approaches the handle slot 11, under the action of a common magnetic field of the left lock buckle magnet 14, the right lock buckle magnet 15, the handle adsorption magnet 16, and the connection block magnet 22, the connection block 21 is sucked in and embedded with the handle slot 11, and the left and right lock buckles slide in the corresponding lock buckle chutes to clamp connection block slots 23 on two sides of the connection block 21, thereby completing locking for the connection block 21.

An unlocking device is further disposed on the top of the handle 1, and the unlocking device includes an unlocking button 17, an unlocking upper slant face 31, and an unlocking lower slant face 32. The unlocking upper slant face 31 respectively abuts against an upper slant face of the left lock buckle 12 and an upper slant face of the right lock buckle 13. The unlocking lower slant face 32 respectively abuts against a lower slant face of the left lock buckle 11 and a lower slant face of the right lock buckle 12. Based on that the unlocking button 17 is triggered, the unlocking upper slant face 31 and the unlocking lower slant face 32 move downward and drive the upper and lower slant faces of the left lock buckle 12 and the right lock buckle 13 to move transversely, so that the left lock buckle 12 and the right lock buckle 13 are disengaged from the connection block 21.

Specifically, a down-pressing travel space is reserved in the unlocking button 17. When the unlocking button 17 is not pressed, the unlocking button 17 is still in a state pre-tightened by an internal spring. When the user presses the unlocking button 17, the unlocking upper slant face 31 respectively abuts against an upper slant face 18 of the left lock buckle 12 and an upper slant face 19 of the right lock buckle 13, and the unlocking lower slant face 32 respectively abuts against a lower slant face 18 of the left lock buckle 12 and a lower slant face 19 of the right lock buckle 13. A downward pressing pressure of the unlocking button 17 is converted into a lateral push force and a sliding action of the left and right lock buckles, so that the left and right lock buckles overcome a magnetic suction force with the connection block 21 and are completely disengaged from the connection block slots 23. The unlocking button 17 maintains a down-pressing position. In this case, the left and right lock buckles also maintain positions completely away from the connection block slots 23. The connection block 21 is quickly disengaged from the handle slot 11 by pulling the glove woven tape 2, so as to complete quick disassembly of the glove woven tape 2 from the handle 1. The unlocking button 17 can be released to rebound after the connection block is disengaged, so that the left and right lock buckles are repelled away from each other again to wait for next assembling.

In the embodiment of this application, quick assembly between the handle and the glove woven tape is implemented under the action of a common magnetic field of the left lock buckle magnet, the right lock buckle magnet, the handle adsorption magnet, and the connection block magnet; and quick disassembly between the handle and the glove woven tape is implemented by using the physical unlocking device.

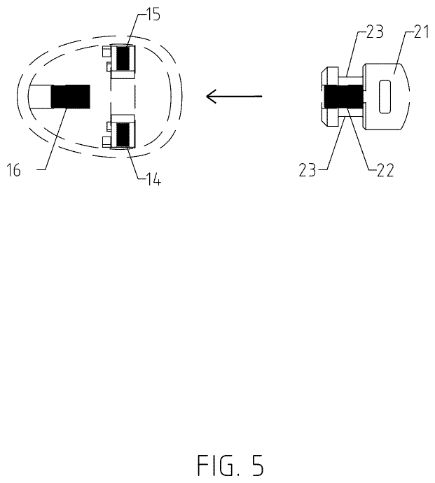

In an embodiment of this application, referring to FIG. 5, magnetic poles of the handle adsorption magnet 16 and the connection block magnet 22 are set to be mutually attracted. When the connection block approaches the handle slot, the connection block is capable of being automatically sucked into the handle slot. Magnetic poles of the left lock buckle magnet and the right lock buckle magnet are set to be mutually repelled.

The magnetic pole of the handle adsorption magnet 16 and the magnetic poles of the left lock buckle magnet 14 and the right lock buckle magnet 15 are mutually repelled, so that the left lock buckle 12 and the right lock buckle 13 are separated from each other, and the connection block 21 is quickly clamped in. While the connection block 21 is completely sucked into the handle slot 11, the magnetic poles of the left lock buckle magnet 14 and the right lock buckle magnet 15 and the magnetic pole of the connection block magnet 22 are opposite in directions, and left lock buckle magnet 14, the right lock buckle magnet 15, and the connection block magnet 22 are mutually attracted. This attractive force is greater than a sum of a repelling force between the left lock buckle magnet 14 and the right lock buckle magnet 15 and a repelling force of the handle adsorption magnet 16 against the left and right lock buckle magnets, so that the left and right lock buckle magnets are firmly adsorbed to the connection block slot 23 and lock the connection block 21 under the action of the magnetic attractive force.

The handle adsorption magnet 16 and the connection block magnet 22 are both cylindrical, and the left lock buckle magnet 14 and the right lock buckle magnet 15 are both in the shapes of arc-shaped tiles. To achieve magnetic interaction between the magnets, the magnets may be permanent magnets such as neodymium-iron-boron permanent magnets, cobalt permanent magnets, and samarium-cobalt magnets. The size and magnetic force of the handle adsorption magnet 16 are the same as those of the connection block magnet 22 as much as possible.

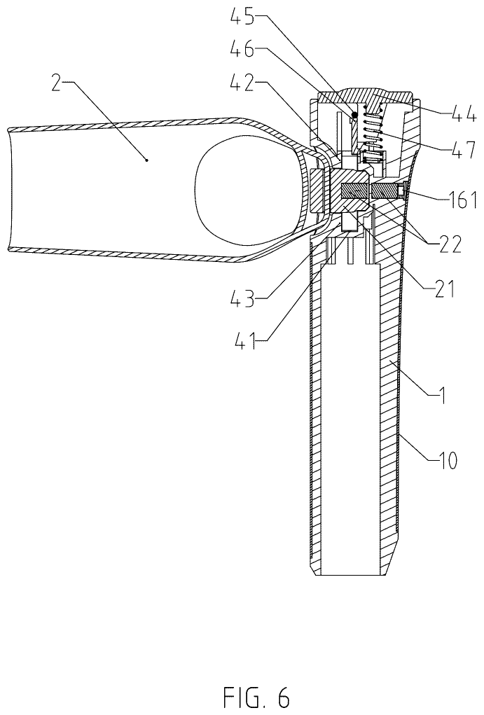

In an embodiment of this application, referring to FIG. 6, the handle adsorption magnet 16 is assembled in a handle magnet mounting hole (not shown in the figure) disposed in the handle 2, and the lock buckle chutes 41 corresponding to the left lock buckle 12 and the right lock buckle 13 are both disposed between the handle magnet mounting hole and the handle slot 11. A lock buckle upper blocking wall 42 is disposed at upper ends of the lock buckle chutes 41 corresponding to the left and right lock buckles, and a lock buckle lower blocking wall 43 is disposed at lower ends of the lock buckle chutes corresponding to the left and right lock buckles.

In the embodiment of this application, the lock buckle chute is configured to slide the left and right lock buckles, and the left and right lock buckles are symmetrically arranged transversely. The lock buckle upper blocking wall is disposed at the upper ends of the lock buckle chutes corresponding to the left and right lock buckles, and the lock buckle lower blocking wall is disposed at the lower ends of the lock buckle chutes corresponding to the left and right lock buckles. Only when the left and right lock buckles slide transversely and are completely disengaged from the handle slot, the glove woven tape can be unlocked and disassembled, thereby avoiding a risk that the left and right lock buckles are disengaged by themselves caused by the fact the handle is rushed when in use, and fully ensuring structural reliability when in use in a locking state.

In an embodiment of this application, referring to FIG. 6, the unlocking button includes a button 44, and a button fixed pin 45, a button fixed pin limiting rib 46, and a button spring 47 that are fixedly connected to the back of the button 44 by using a spring mounting seat.

In the embodiment of this application, locking of the left and right lock buckles for the connection block is released in a mechanical manner of pressing the button, thereby fully ensuring structural reliability when in use in the locking state.

In conclusion, the present disclosure provides a magnetic type quick-assemble and quick-disassemble structure for a handle and a glove woven tape. Main technical concepts of the present disclosure have the following advantages. Quick assembly between the handle and the glove woven tape is implemented under the action of the common magnetic field of the left lock buckle magnet, the right lock buckle magnet, the handle adsorption magnet, and the connection block magnet. Quick disassembly between the handle and the glove woven tape is implemented by using the physical unlocking device. When the left and right lock buckles slide transversely and are completely disengaged from the handle slot, the glove woven tape can be unlocked and disassembled, thereby avoiding a risk that the left and right lock buckles are disengaged by themselves caused by the fact the handle is rushed when in use, and fully ensuring structural reliability when in use in a locking state.

The present disclosure is described in detail above. In the present disclosure, specific examples are applied to clarify the principle and implementations of the present disclosure, and descriptions about the above embodiments are only used for understanding the method and main idea of the present disclosure. It should be noted that those skilled in the art may make several improvements or modifications without departing from the principle of the present disclosure and the improvements or modifications shall fall within the protection scope of claims in the present disclosure.

What is claimed is:

1. A magnetic type quick-assemble and quick-disassemble structure for a handle and a glove woven tape, comprising a handle and a glove woven tape, wherein a connection block is disposed at a first web of the glove woven tape, and a connection block magnet is disposed in the connection block; a handle slot adapted to the connection block is embedded in the handle, and a left lock buckle and a right lock buckle are symmetrically disposed on two sides of the handle slot along an insertion direction of the connection block, wherein the left lock buckle and the right lock buckle are respectively disposed in corresponding lock buckle chutes, and a left lock buckle magnet and a right lock buckle magnet are correspondingly disposed in the left lock buckle and the right lock buckle; a handle adsorption magnet is disposed in front of the handle slot along the insertion direction of the connection block; and when the connection block approaches the handle slot, under the action of a common magnetic field of the left lock buckle magnet, the right lock buckle magnet, the handle adsorption magnet, and the connection block magnet, the left and right lock buckles slide in the corresponding lock buckle chutes to clamp the connection block; and
an unlocking device is further disposed on the top of the handle, and the unlocking device comprises an unlocking button, an unlocking upper slant face, and an unlocking lower slant face; the unlocking upper slant face respectively abuts against an upper slant face of the left lock buckle and an upper slant face of the right lock buckle, the unlocking lower slant face respectively abuts against a lower slant face of the left lock buckle and a lower slant face of the right lock buckle, based on that the unlocking button is triggered, the unlocking upper slant face and the unlocking lower slant face move downward and drive the upper and lower slant faces of the left lock buckle and the right lock buckle to move transversely, so that the left lock buckle and the right lock buckle are disengaged from the connection block.

2. The magnetic type quick-assemble and quick-disassemble structure for a handle and a glove woven tape according to claim 1, wherein magnetic poles of the handle adsorption magnet and the connection block magnet are set to be mutually attracted; and when the connection block approaches the handle slot, the connection block is capable of being automatically sucked into the handle slot.

3. The magnetic type quick-assemble and quick-disassemble structure for a handle and a glove woven tape according to claim 1, wherein magnetic poles of the left lock buckle magnet and the right lock buckle magnet are set to be mutually repelled.

4. The magnetic type quick-assemble and quick-disassemble structure for a handle and a glove woven tape according to claim 1, wherein the handle adsorption magnet and the connection block magnet are both cylindrical, and the left lock buckle magnet and the right lock buckle magnet are both in the shapes of arc-shaped tiles.

5. The magnetic type quick-assemble and quick-disassemble structure for a handle and a glove woven tape according to claim 1, wherein a handle magnet mounting hole is disposed in the handle, and the lock buckle chutes corresponding to the left lock buckle and the right lock buckle are both disposed between the handle magnet mounting hole and the handle slot.

6. The magnetic type quick-assemble and quick-disassemble structure for a handle and a glove woven tape according to claim 5, wherein a lock buckle upper blocking wall is disposed at upper ends of the lock buckle chutes corresponding to the left and right lock buckles, and a lock buckle lower blocking wall is disposed at lower ends of the lock buckle chutes corresponding to the left and right lock buckles.

7. The magnetic type quick-assemble and quick-disassemble structure for a handle and a glove woven tape according to claim 1, wherein the unlocking button comprises a button, and a spring and a button fixed pin limiting rib that are fixedly connected to the back of the button by using a spring mounting seat; wherein the spring is configured to control movement of the unlocking upper slant face and the unlocking lower slant face.
